(19) United States
(12) Patent Application Publication
(10) Pub. No.: US 2026/0120182 A1
(43) Pub. Date: Apr. 30, 2026

(54) Graphical User Interfaces and Systems, Methods, and Computer-Readable Media for Providing Graphical User Interfaces

(71) Applicant: Xero Limited, Te Aro, Wellington (NZ)

(72) Inventors: Molly Nicoll, Te Aro, Wellington (NZ); Adam Huskisson, Te Aro, Wellington (NZ)

(21) Appl. No.: 18/881,156

(22) PCT Filed: Jun. 27, 2023
(86) PCT No.: PCT/NZ2023/050062

§ 371 Date: Jan. 3, 2025

(30) Foreign Application Priority Data
Jul. 7, 2022 (AU) 2022901903
Sep. 7, 2022 (AU) 2022902574

(51) Int. Cl. G06Q 40/02

(52) U.S. Cl. CPC G06Q 40/026; G06Q 40/023

(57) ABSTRACT

A method includes presenting, in a user interface for a user account with an online platform, a first display object comprising a payment progress indicator representative of a payment plan for paying a debt. The payment plan is a combination payment plan comprising at least two different payment schedules. The indicator comprises a first component representative of a first of the payment schedules and a second component representative of a second of the payment schedules. The first component is distinct from the second component. Responsive to determining that a payment has been received, the method comprises modifying at least a portion of the respective first or second components to indicate that the payment has been made.

### TECHNICAL FIELD

Embodiments relate to systems, methods, and computer-readable media for providing graphical user interfaces (GUIs) and GUIs. In particular, embodiments relate to GUIs for providing intuitive representations of payment schedules.

### BACKGROUND

Conveying of aspects of financial information on a user interface, and in particular user interfaces being provided on displays with relatively small real estate, such as those of mobile devices, can prove difficult. Often visual representations of such financial information can be incomprehensible and/or meaningless, and are not effective in communicating the relevant information to a user in an efficient and intuitive manner.

It is desired to address or ameliorate one or more shortcomings or disadvantages associated with such prior art, or to at least provide a useful alternative hereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments are related to a computer-implemented method comprising: presenting, on a first display device of a first device of a first user, a user interface for a user account with an online platform; presenting, in the user interface, a first display object comprising a payment progress indicator representative of a payment plan for paying a debt; wherein the payment plan is a combination payment plan comprising at least two different payment schedules, wherein the payment progress indicator comprises a first component representative of a first of the payment schedules of the combination payment plan and a second component representative of a second of the payment schedules of the combination payment plan, and wherein the first component is distinct from the second component, and responsive to determining that a payment has been received, determining to which of the first and second payment schedules it relates; and modifying at least a portion of the respective first or second components to indicate that the payment has been made.

Some embodiments are directed to a computer-implemented method comprising: presenting, on a first display device of a first device of a first user, a user interface for a user account with an online platform, the user interface providing a first display object comprising a first user selectable option to select a payment plan type from a set of payment plan types for paying a debt, wherein at least one of the payment plan types of the set is a combination payment plan comprising at least two different payment schedules; determining, by the processor, a user selected combination payment plan from the set of payment plan types; and presenting, in the user interface, a second display object comprising a payment progress indicator, wherein the payment progress indicator comprises a first component representative of a first of the payment schedules of the combination payment plan and a second component representative of a second of the payment schedules of the combination payment plan, and wherein the first component is distinct from the second component, and responsive to determining that a payment has been received, determining to which of the first and second payment schedules it relates; and modifying at least a portion of the respective first or second components to indicate that the payment has been made.

In some embodiments, the method comprises presenting, in the user interface, a third display object comprising a second user selectable option to create an invoice or bill associated with the debt for a second user; determining, by the processor, that the first user selectable option to create the invoice or bill for the second user has been selected; and presenting, in the user interface the first display object to allow the user to select the payment plan type for the invoice or bill.

In some embodiments, the method comprises presenting, on a second display device of a second device of the second user, a fourth display object comprising the invoice or bill and the progress payment indicator.

Some embodiment relate to computer-implemented method comprising: presenting, on a display device of a first device, a user interface for a user account with an online platform, the user interface providing a first display object comprising a first user selectable option displaying an invoice or bill associated with a debt; presenting, in the user interface, a second display object comprising a first user selectable option to select a payment plan type from a set of payment plan types for the debt, wherein at least one of the payment plan types of the set is a combination payment plan comprising at least two different payment schedules; determining, by the processor, a user selected combination payment plan from the set of payment plan types; and presenting, in the user interface, a third display object comprising a payment progress indicator, wherein the payment progress indicator comprises a first component representative of a first of the payment schedules of the combination payment plan and a second component representative of a second of the payment schedules of the combination payment plan, and wherein the first component is distinct from the second component; and responsive to determining that a payment has been received, determining to which of the first and second payment schedules it relates; and modifying at least a portion of the respective first or second components to indicate that the payment has been made.

Some embodiments relate to a computer-implemented method comprising: presenting, on a first display device of a first device of a first user, a user interface for an e-commerce website, the user interface providing a first display object comprising a first user selectable option to purchase an item from the e-commerce website; determining, by the processor, that the first user selectable option to purchase the item has been selected; presenting, in the user interface, a second display object comprising a second user selectable option to select a payment plan type from a set of payment plan types for payment of the item, wherein at least one of the payment plan types of the set is a combination payment plan comprising at least two different payment schedules; determining, by the processor, a user selected combination payment plan from the set of payment plan types; and presenting, in the user interface, a third display object comprising a payment progress indicator, wherein the payment progress indicator comprises a first component representative of a first of the payment schedules of the combination payment plan and a second component representative of a second of the payment schedules of the combination payment plan, and wherein the first component is distinct from the second component; and responsive to determining that a payment has been received, determining to which of the first and second payment schedules it relates; and modifying at least a portion of the respective first or second components to indicate that the payment has been made.

In some embodiments, the first and/or second component comprises one or more elements, and wherein modifying the at least a portion of the respective first or second component representative to indicate that the payment has been made comprises adjusting an appearance of at least one of the one or more elements.

In some embodiments, adjusting the appearance of at least one element comprises one or more of: (i) increasing or decreasing a size of the at least one element; (ii) changing a shape of the at least one element; (iii) changing a colour of the at least one element; and (iv) shading or hashing the at least one element.

In some embodiments, adjusting the appearance of at least one of the one or more elements comprises adjusting the appearance of the at least one of the one or more elements by an adjustment measure, and wherein the adjustment measure is reflective of the received payment relative to an overall amount of the debt.

In some embodiments, the first component comprises a progressive bar and wherein modifying the appearance of the progressive bar comprises progressing a slider of the progressive bar from a first side of the progressive bar toward a second side of the progressive bar by the adjustment measure.

In some embodiments, the at least one element of the second component comprises a single section indicative of a deposit payment.

In some embodiments, the at least one element of the first component comprises a single section indicative of a deposit payment.

In some embodiments, the at least one element of the first component comprises a plurality of elements, each element being a non-contiguous section, and each non-contiguous section being indicative of an instalment of the respective payment schedule of the first component.

In some embodiments, the at least one element of the second component comprises a plurality of elements, each element being a non-contiguous section, and each non-contiguous section being indicative of an instalment of the respective payment schedule of the second component.

In some embodiments, the non-contiguous sections are equally sized representing equally sized instalments.

In some embodiments, at least some of the non-contiguous sections are different in size, representing respective differently sized instalments.

In some embodiments, the method further comprises: determining, by the processor, a first due date associated with the first payment schedule of the combination payment plan and a second due date associated with the second payment schedule, wherein the first due date is the date by which a first portion of the debt as represented by the first component is due to be paid and the second due date is the date by which a second portion of the debt as represented by the second component is due to be paid.

In some embodiments, the second due date is later than the first due date.

In some embodiments, the method further comprises: determining, by the processor, a plurality of consecutive second intermittent due dates, wherein each second intermittent due date is the date by which an instalment of the second payment schedule is due to be paid, and wherein a latest of the second intermittent due dates corresponds to the second due date.

In some embodiments, the plurality of consecutive second intermittent due dates is determined based on a number of instalments to be made or a regular payment cycle.

In some embodiments, determining, by the processor, the first due date and the second due date comprises receiving as user inputs, the first due date and the second due date.

In some embodiments, the second component is positioned alongside the first component within the progress indicator.

In some embodiments, the online platform is an online bookkeeping/accounting platform maintaining bookkeeping accounts for a plurality of entities and providing an online bookkeeping service to users.

In some embodiments, the method may further comprise: responsive to determining that an overpayment has been made: determining a modified first and/or second payment schedule based on the overpayment; and modifying at least a portion of the respective first and/or second components to reflect the overpayment. For example, determining the modified first and/or second payment schedule based on the overpayment comprising one or more of: (i) reducing an amount of a next instalment due by the amount of the overpayment; (ii) reducing an amount of one or more remaining instalment; (iii) reducing a frequency of future instalments; and/or (iv) reducing a number of future repayments.

In some embodiments, the method may further comprise: responsive to determining that an underpayment has been made: determining a modified first and/or second payment schedule based on the underpayment; and modifying at least a portion of the respective first and/or second components to reflect the underpayment. For example, determining the modified first and/or second payment schedule based on the underpayment comprising one or more of: (i) increasing an amount of a next instalment due by the amount of the overpayment; (ii) increasing an amount of one or more remaining instalment; (iii) increasing a frequency of future instalments; and/or (iv) increasing a number of future repayments.

Some embodiments are directed to a system comprising: memory having instructions embodied thereon; and one or more processors configured by the instructions to perform the method according to any of the described embodiments.

In some embodiments, the system further comprises the display device of the first device.

Some embodiments are directed to a non-transitory machine-readable storage medium storing instructions which, when executed by one or more processors, cause the one or more processors to perform the method according to any of the described embodiments.

Some embodiments are directed to a graphical user interface (GUI) for display on a display screen of a user device, the GUI comprising: a first frame occupying a first frame region of a window occupying all or a portion of the display screen; a payment progress indicator displayed within the first frame, the payment progress bar being representative of a combination payment plan for payment of invoice debt, the combination payment plan comprising at least two different payment schedules, wherein the payment progress indicator comprises a first component representative of a first of the payment schedules of the combination payment plan and a second component representative of a second of the payment schedules of the combination payment plan, wherein the first component is distinct from the second component, and wherein, responsive to determination of payment associated with one of the first and second payment schedules, at least a portion of the respective first or second component representative is modified to indicate that the payment has been made.

In some embodiments, the GUI further comprises a second frame occupying a second frame region of the window; a payment plan display object displayed within the second frame, the payment plan comprising a user selectable option to select a payment plan type from a set of payment plan types for payment of the debt, wherein at least one of the payment plan types of the set is the combination payment plan.

In some embodiments of the described GUI, the second component is positioned alongside the first component within the progress indicator.

In some embodiments of the described GUI, the first and/or second component comprises one or more elements, and wherein the at least a portion of the respective first or second component representative is modified to indicate that the payment has been made by adjusting an appearance of at least one of the one or more elements.

In some embodiments of the described GUI, the appearance of at least one element is adjusted by one or more of: (i) increasing or decreasing a size of the at least one element; (ii) changing a shape of the at least one element; (iii) changing a colour of the at least one element; and (iv) shading or hashing the at least one element.

In some embodiments of the described GUI, the appearance of at least one of the one or more elements is adjusted by an adjustment measure, and wherein the adjustment measure is reflective of the received payment relative to an overall amount of the debt.

In some embodiments of the described GUI, the first component comprises a progressive bar and wherein the appearance of the progressive bar is modified by progressing a slider of the progressive bar from a first side of the progressive bar toward a second side of the progressive bar by the adjustment measure.

In some embodiments of the described GUI, the at least one element of the second component comprises a single section indicative of a deposit payment.

In some embodiments of the described GUI, the at least one element of the first component comprises a single section indicative of a deposit payment.

In some embodiments of the described GUI, the at least one element of the first component comprises a plurality of elements, each element being a non-contiguous section, and each non-contiguous section being indicative of an instalment of the respective payment schedule of the first component.

In some embodiments of the described GUI, the at least one element of the second component comprises a plurality of elements, each element being a non-contiguous section, and each non-contiguous section being indicative of an instalment of the respective payment schedule of the second component.

In some embodiments of the described GUI, the non-contiguous sections are equally sized represented equally sized instalments.

In some embodiments of the described GUI, the at least some of the non-contiguous sections are different in size, representing respective differently sized instalments.

In some embodiments of the described GUI, the GUI is a single page application, or is a part of a single page application.

In some embodiments of the described GUI, the GUI is part of an online bookkeeping system providing an online bookkeeping service to users, the graphical user interface being accessible to the first user.

In some embodiments, responsive to determining that an overpayment has been made, the GUI is configured to determine a modified first and/or second payment schedule based on the overpayment; and modify at least a portion of the respective first and/or second components to reflect the overpayment. For example, determining the modified first and/or second payment schedule based on the overpayment may comprise one or more of: (i) reducing an amount of a next instalment due by the amount of the overpayment; (ii) reducing an amount of one or more remaining instalment; (iii) reducing a frequency of future instalments; and/or (iv) reducing a number of future repayments.

In some embodiments, responsive to determining that an underpayment has been made, the GUI is configured to determine a modified first and/or second payment schedule based on the underpayment; and modify at least a portion of the respective first and/or second components to reflect the underpayment. For example, determining the modified first and/or second payment schedule based on the underpayment may comprise one or more of: (i) increasing an amount of a next instalment due by the amount of the overpayment; (ii) increasing an amount of one or more remaining instalment; (iii) increasing a frequency of future instalments; and/or (iv) increasing a number of future repayments.

### BRIEF DESCRIPTION OF DRAWINGS

Various ones of the appended drawings merely illustrate example embodiments of the present disclosure and cannot be considered as limiting its scope.

FIGS. 1A to 1E are example image of payment progress indicators depicting different combination payment plan types, according to some embodiments;

FIG. 2 is a block diagram of a system for providing an interface configured to provide intuitive representations of payment schedules to a user of a user device, according to some embodiments;

FIG. 3 is a is a process flow diagram of a method for providing an interface configured to provide intuitive representations of payment schedules by a user of the user device, according to some embodiments;

FIG. 4 is an example images of a payment progress indicator as it is modified in response to determination of payments being made, according to some embodiments;

FIG. 5 is an example image of a first display object of a user interface comprising a user selectable option to create an invoice, and a second display object of the user interface comprising a user selectable option to select a payment plan type, according to some embodiments;

FIGS. 6A to 6E are example images of a display object of a user interface comprising a user selectable option to select a payment plan type, according to some embodiments;

FIG. 7 is an example image of a display object of a user interface comprising a payment progress indicator and a list of payments paid and/or due according to the payment schedules of the combination payment plan being represented by the payment progress indicator, according to some embodiments;

FIG. 8 is an example image of a display object of a user interface comprising an invoice and a progress payment indicator associated with the invoice, according to some embodiments;

FIG. 9 is an example image of a display object of a user interface comprising a progress payment indicator associated with the invoice, according to some embodiments;

FIGS. 10A to 10E are example images of payment progress indicators depicting an overpayment, according to some embodiments; and

FIGS. 11A to 11D are example images of payment progress indicators depicting an underpayment, according to some embodiments.

### DESCRIPTION OF EMBODIMENTS

Embodiments relate to systems, methods, and computer-readable media for providing graphical user interfaces (GUIs) and GUIs. In particular, embodiments relate to GUIs for providing intuitive representations of payment schedules.

Various payment plan types can be used to facilitate payment of a purchase or debt, such as an invoice or bill. For example, payment plan types may include a progressive partial payments or fixed instalments, where a payee makes a plurality of progressive part payments until the total amount has been paid. Payment plan types may also include combination payment plan types. Such combination payment plan types comprise a plurality of distinct payment plans, each having a respective payment schedule.

For example, a combination payment plan may comprise a first payment plan having a first payment schedule, and a second payment plan having a second payment schedule, distinct from the first payment schedule. Each payment schedule of a payment plan may comprises one or more due dates. For example, a payment schedule may comprise payment of a specific amount by a specific due date, such as a deposit. A payment schedule may comprise payment of a plurality of fixed or variable instalments, each instalment having a respective instalment due date. The final due date of such a payment schedule may correspond with the last or final instalment due date.

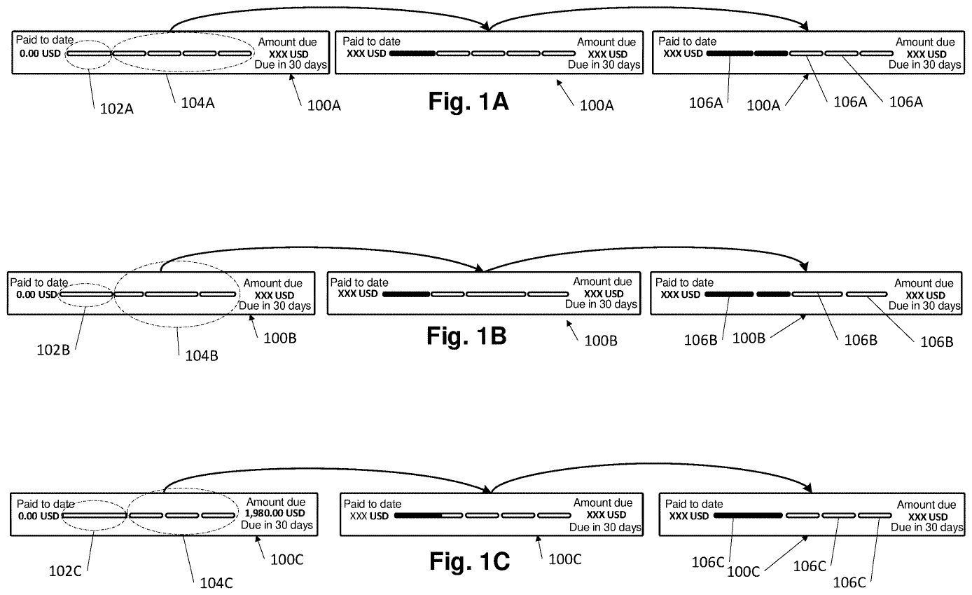

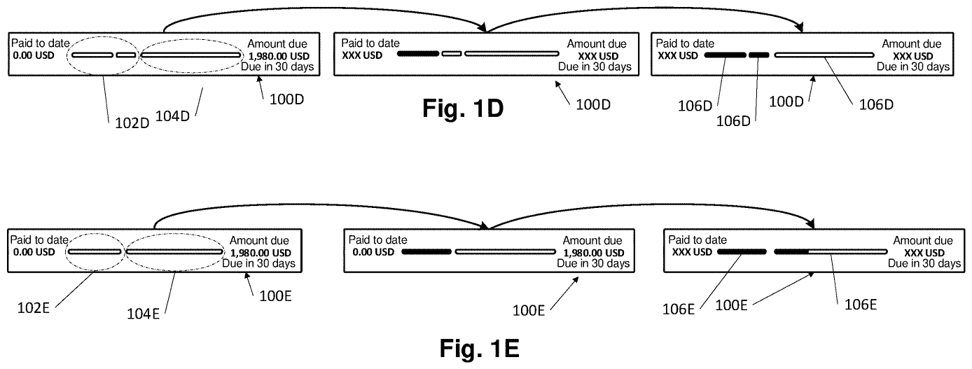

FIGS. 1A to 1E each depict a payment progress indicator 100A to 100E, which may be provided as a display object or element of a graphical user interface, according to the described embodiments. Each of the payment progress indicators 100A to 100E comprises a first component 102A to 102E representative of a first payment schedule, and a second component 104A to 104E representative of a first payment schedule. The first component 102A to 102E and second components 104A to 104E are distinct from one another. Each of FIGS. 1A to 1E illustrates three instances or states of a payment progress indicator 100A-100E as successive part payments or instalments of a debt (such as an invoice, bill, or loan for example) are received.

A first due date may be associated with the first payment schedule of the combination payment plan and a second due date may be associated with the second payment schedule. The first due date may be the date by which a first portion of the debt as represented by the first component is due to be paid and the second due date may be the date by which a second portion of the debt as represented by the second component is due to be paid. The second due date may be later than the first due date. In some embodiments, the first and/or second due date may comprise a plurality of consecutive intermittent due dates, wherein each intermittent due date is the date by which an instalment or part or progress payment of the first and/or second payment schedule is due to be paid. A latest of the intermittent due dates may correspond to the respective first and/or second due date. In some embodiments, the plurality of consecutive second intermittent due dates may be determined based on a number of instalments to be made or a regular payment cycle.

Referring to FIG. 1A, the payment progress indicator 100A represents a combination payment plan type comprising two different payment schedules. The first component 102A of the payment progress indicator 100A is a single section or element 106A representing a deposit payment. The second component 104A comprises a plurality of elements 106A, each element 106A being an equally sized, non-contiguous section representing an instalment payment of equal amount/value. Once payment of the deposit is paid/received, the payment progress indicator 100A transitions to the second image wherein the first component 102A representing the deposit has been modified in appearance to reflect that the deposit payment has been paid/received; in this case, the first component 102A has been shaded in. Once payment of a first instalment of the second payment schedule is received, the payment progress indicator 100A transitions to the third image wherein the first element 106A of the second component has been modified in appearance to reflect that the first instalment has been paid/received; in this case, the first element 106A has been shaded in. As subsequent instalments are paid/received, respective elements 106A of the payment progress indicator 100A are modified in appearance to indicate or reflect that the respective instalment has been paid/received.

Referring to FIG. 1B, the payment progress indicator 100B represents a combination payment plan type comprising two different payment schedules. The first component 102B of the payment progress indicator 100B is a single section or element 106 B representing a deposit payment. The second component 104B comprises a plurality of elements 106B, each element 106 B being non-contiguous section representing an instalment payment. In this embodiments, and in contrast with the embodiment of FIG. 1A, one or more of the elements 106B (i.e. the non-contiguous sections) differ in size to others of the elements 106B, and accordingly, represent difference amounts/values of instalment payments. As with the embodiments of FIG. 1A, as successive payments are made/received, the respective elements 106A of the components 102B, 104B modified in appearance to reflect the payment.

Referring to FIG. 1C, the payment progress indicator 100C represents a combination payment plan type comprising two different payment schedules. The first component 102C of the payment progress indicator 100C is a progressive bar. As part payment or instalments are received/paid according to the payment schedule associated with the first component 102C, the appearance of the progressive bar is modified by progressing a slider of the progressive bar from a first side of the progressive bar toward a second side of the progressive bar by an adjustment measure. The adjustment measure may be reflective of or indicative of the received/paid part payment or instalment relative to an overall amount of the debt attributed to or associated with the payment schedule of the first component 102C. For example, if 50% of the amount due to be paid according to the payment schedule of the first component 102C is received/paid, the slider of the progressive bar may progress to 50% along the progressive bar of the payment progress indicator 100C. In some embodiments, the progressive bar may represent a flexible payment arrangement whereby the payer is authorised to make various sized part payments or instalments, and in some embodiments, any sized instalment. In some embodiments, the part payments or instalments are fixed sized or amount instalments. The progressive bar, by way of the slider, may illustrate the part payment or instalments as a continuous flow of payment, as opposed to the instalments represented by non-contiguous elements as with the embodiment of FIG. 1B, for example. Similar to the second component 104A of the payment progress indicator 100A of FIG. 1, the second component 104C of the payment progress indicator 100C comprises a plurality of elements 106C, each element 106C being an equally sized non-contiguous section representing an instalment or part payment of equal amount/value. It will be appreciated that in other embodiments, similar to that of FIG. 1B, the plurality of elements 106C of the second component 104C may be non-contiguous sections that differ in size to others of the elements 106B, and accordingly, represent difference amounts/values of instalment or part payments.

As with the embodiments of FIG. 1A, as successive payments are made/received, the respective elements 106C of the components 102C, 104C are modified in appearance to reflect the payment, by progressing the progressive bar of the first component 102C by the adjustment amount and/or modifying the appearance of the appropriate non-contiguous section of the second component 104C.

Referring to FIG. 1D, the payment progress indicator 100D represents a combination payment plan type comprising two different payment schedules. The first component 102D of the payment progress indicator 100D comprises a plurality of elements 106D, each element 106D being an equally sized non-contiguous section representing an instalment or part payment of equal amount/value (similar to the elements of the second component 104B of FIG. 1B). The second component 104D of the payment progress indicator 100D is a progressive bar (similar to component 102C of FIG. 1C). As successive payments are made/received, the respective elements 106D of the components 102D, 104D are modified in appearance to reflect the payment, by modifying the appearance of the appropriate non-contiguous section of the first component 102D and/or progressing the progressive bar of the second component 104D by the adjustment amount.

Referring to FIG. 1E, the payment progress indicator 100E represents a combination payment plan type comprising two different payment schedules. The first component 102E of the payment progress indicator 100E is a single section or element 106A representing a deposit payment. The second component 104E of the payment progress indicator 100E is a progressive bar (similar to component 102C of FIG. 1C). As successive payments are made/received, the respective elements 106E of the components 102E, 104E are modified in appearance to reflect the payment, by modifying the appearance of the element 106E of the first component 102E and/or progressing the progressive bar of the second component 104E by the adjustment amount.

The GUI providing the payment progress indicators of the described embodiments provide intuitive representations of payment schedules determined from stored data, and in particular different payment schedules of a combination payment plan. The payment progress indicators can be configured to accommodate or represent various types and combinations of payment schedules. The payment progress indicators are readily interpretable and easy to use, facilitating the conveyance of multiple pieces of information about the debt (such as invoices) or payments due and/or paid. For example, the payment progress indicators readily convey a type of payment paid, or due, and a relative amount of the debt paid/due. In this way, the GUI providing payment progress indicators maximise the utility of a finite area provided by a display screen of the user device. This is particularly advantageous where the user device is a mobile device having a relative small amount of screen real estate available to readily convey information to a user. The GUI providing the payment progress indicators of the described embodiments make it easy for customers to understand or appreciate how much of a debt (such as a bill, loan or invoice) they have paid, and how much remains outstanding, and in some embodiments, how many payments they have made and how many more they are expected to make. The GUI providing the payment progress indicators of the described embodiments may also save a merchant time and effort in that the merchant may elect to send a single invoice, bill, or credit statement including the payment progress indicator to a customer rather than multiple documents reflecting each payment made. This time saving efficiency extends into reporting, reconciliation of payment and tracking/managing invoices.

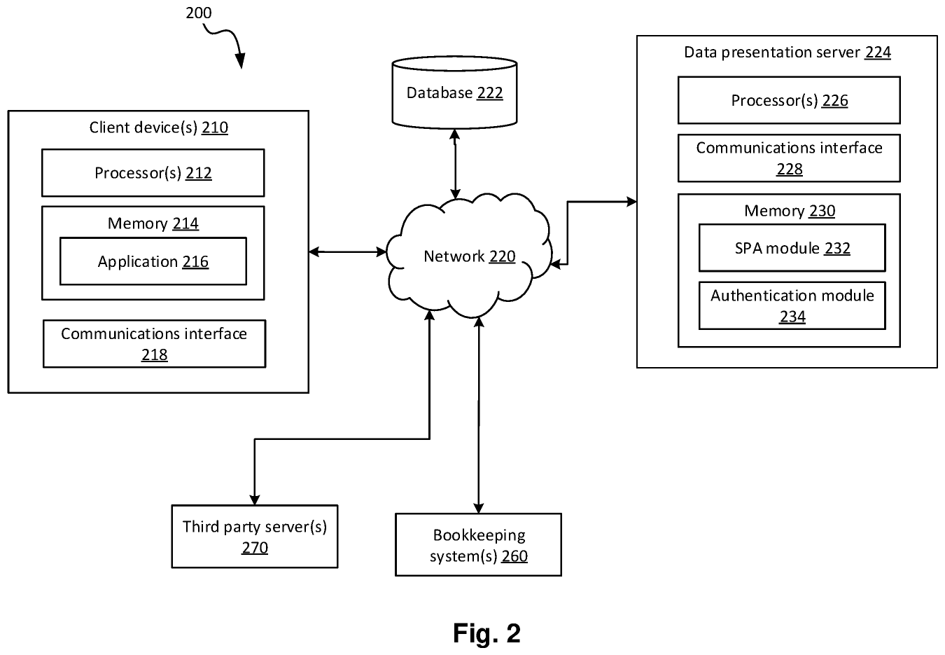

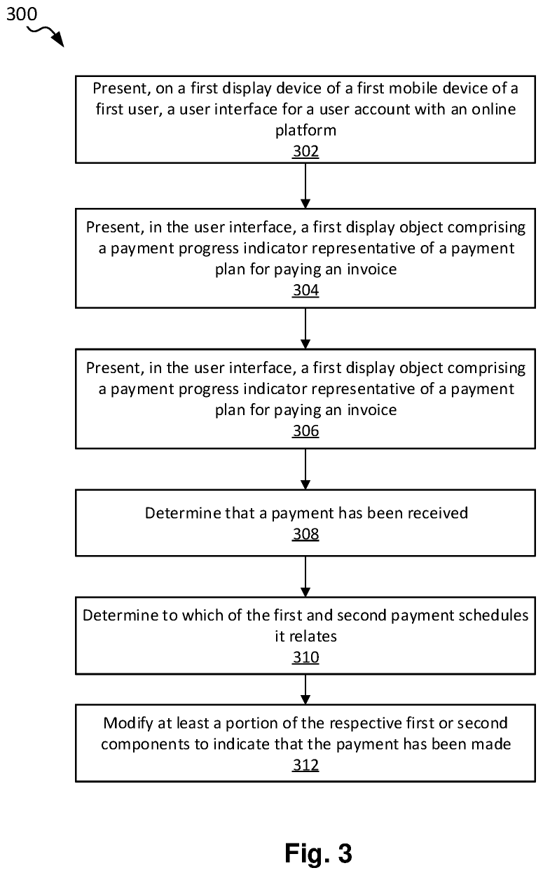

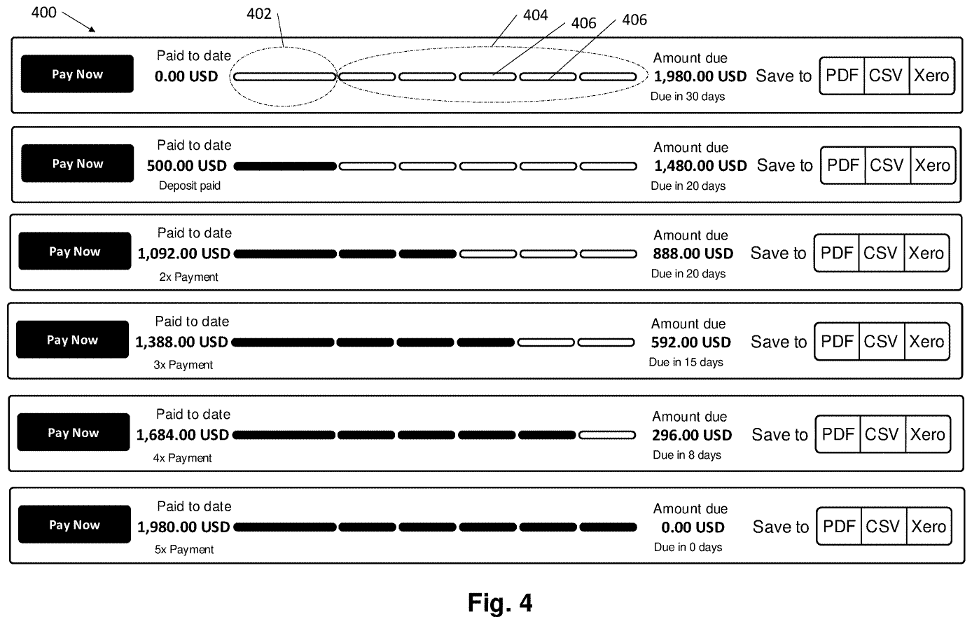

FIG. 2 is a block diagram of system 200 for provide an interface enabling intuitive understanding of payment schedules associated with an invoice or purchase by a user of a user device 110, according to some embodiments. The system 200 of FIG. 2 provides means for implementing the method illustrated in process flow diagram FIG. 3, and means for implementing the graphical user interfaces (GUIs) illustrated in FIGS. 4, 5 and 6.

As illustrated, the system 200 may comprise one or more client device(s) 210, external database 222, data presentation server 224, one or more bookkeeping system(s) 260 and/or one or more third party server(s) 270 in communication over a network 220.

Client device 210 may comprise a mobile or handheld computing device such as a smartphone or tablet, a laptop, or a PC, and may, in some embodiments, comprise multiple computing devices. The client device 210 may comprise one or more processor(s) 212, memory 214 and/or communications interface 218. The processor(s) 212 may comprise one or more microprocessors, central processing units (CPUs), application specific instruction set processors (ASIPs), application specific integrated circuits (ASICs) or other processors capable of reading and executing instruction code. The processor(s) 212 may be configured to receive stored instructions (i.e. program code) from memory 214, which when executed by the processor(s) 212 may cause the client device 210 to function according to the described embodiments. Client device 210 comprises one or more display screens, the or each of the one or more display screens being configured to display the GUIs illustrated in one or more of FIGS. 4 to 8 in implementing a method such as that illustrated in FIG. 3. Functionality determining arrangement and content of the GUI is provided by the processor hardware 212, and the memory hardware 214, which may be cooperating with data presentation server 224 and/or bookkeeping system 260. The GUI may be an application 216 stored on the memory 214, or part of an application 216 stored on the memory 214. The application 216 may be a single page application served by the data presentation server 224 to the client device 210 over the network 220 and displaying content from (for example, invoices or bills), or based on (for example, payment progress indicators 100A to 100E), data obtained from the bookkeeping system 160.

The memory 214 may comprise application 216 which comprises computer executable code, which when executed by the one or more processors 212, is configured to allow client device 210 to facilitate the intuitive viewing and navigation of data displayed on a screen of the client device 210. The communications interface 218 facilitates communications with components of the communications interface 218 across the network 220, such as: database 222, data presentation server 224, bookkeeping system(s) 260 and/or third party server(s) 170. The communications interface 218 may comprise a combination of network interface hardware and network interface software suitable for establishing, maintaining and facilitating communication over a relevant communication channel.

The network 220 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 220 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The database 222 may form part of or be local to the system 200, or may be remote from and accessible to the system 200, for example, via the communications network 220. The database 220 may be configured to store data associated with the system 200. The database 220 may be a centralised database. The database 220 may be a mutable data structure. The database 220 may be a shared data structure. The database 220 may be a data structure supported by database systems such as one or more of PostgreSQL, MongoDB, and/or ElasticSearch. The database 220 may be configured to store a current state of information or current values associated with various attributes (e.g., “current knowledge”).

The data presentation server 224 may be configured to serve single page applications to the client device 210. Single page applications may comprise GUIs such as those illustrated in FIGS. 3, 4 and/or 5. The GUIs of single page applications provide a mechanism for a user of a client device to view, navigate, manipulate, and/or interact with, data stored by the bookkeeping system 160. The data stored by the bookkeeping system 260 may comprise, inter alia, transaction data such as a transaction feed representing a series of transactions in which the user (or a business or other legal entity on behalf of which the bookkeeping system 160 is providing an online bookkeeping service) has engaged in. For example, the transaction data may comprises one or more payments made from or to the user or their related entity. The data stored by the bookkeeping system 260 may comprise financial documents, such as invoices, bills, receipts, issued to or by the user (or a business or other legal entity on behalf of which the bookkeeping system 160 is providing an online bookkeeping service).

In some embodiments, the data presentation server 224 may comprise one or more processors 226 and memory 230 storing instructions (e.g. program code) which when executed by the processor(s) 226 causes the system 200 to provide an interface comprising a payment progress indicator enabling intuitive understanding of payment schedules of a combination payment plan by a user of a user device, such as client device 210, and/or to function according to the described methods. The processor(s) 226 may comprise one or more microprocessors, central processing units (CPUs), application specific instruction set processors (ASIPs), application specific integrated circuits (ASICs) or other processors capable of reading and executing instruction code.

In some embodiments, the data presentation server 224 may operate in conjunction with or support one or more external devices, such as the client device 210, the database 222, the bookkeeping system(s) 260 and/or the third party server(s) 270, to manage the provision of an intuitive GUI for stored data.

The memory 230 may comprise one or more volatile or non-volatile memory types. For example, memory 230 may comprise one or more of random access memory (RAM), read-only memory (ROM), electrically erasable programmable read-only memory (EEPROM) or flash memory. Memory 230 is configured to store program code accessible by the processor(s) 226. The program code comprises executable program code modules. In other words, memory 230 is configured to store executable code modules configured to be executable by the processor(s) 226. The executable code modules, when executed by the processor(s) 226 cause the system 200 to perform the functionality according to the described embodiments, as described in more detail below. Memory 230 may comprise a single page applications (SPA) module 132, which stores and serves single page applications (SPAs) to user devices such as client devices. Memory 230 may comprise an authentication module 134, which may, for example, check credentials to enable users to login to the service.

FIG. 3 is a process flow diagram of a method 300 of providing a GUI comprising an intuitive payment progress indicator providing intuitive representations of payment schedules of a combination payment plan.

The process of FIG. 3 relates to the stored data domain and the display screen domain, and provides a mechanism for the illustration of information from the stored data domain in the display screen domain. In embodiments, the display screen domain is interactive via the GUI, and so elements of the display screen domain may be selectable, scrollable, and/or scalable. The display screen domain is a manifestation of processing performed by the GUI. The process of FIG. 3 is described below with reference to FIGS. 4, 5 and 6.

An operating system of the client device 210 is responsible for detecting user interactions with the graphical user interface (GUI), and feeding data representing the detected user interactions to the GUI so that the GUI can respond according to the GUI configuration.

Payment progress indicator data belong to the stored data domain. The stored data domain refers to data as stored and transferred between devices of the system 200, as distinct from the manifestation of the stored data that is rendered in the GUI. The payment progress indicator data may be stored in non-volatile storage by the bookkeeping system 260, which entries are accessible to the client device 210 running an SPA served thereto by SPA module 232 of data presentation server 224. The processing instructions implementing the SPA may include instructions for composing and transmitting data access queries to the bookkeeping system 260. The GUI may determine values from or based on the payment progress indicator data visible as numbers or text strings present in the display screen domain. The GUI translates values from the payment progress indicator data in the stored data domain into visual objects or elements present in the display screen domain, such as one or more of the payment progress indicators 100A to 100E.

Referring now to the method 300 of FIG. 3, at 302, the GUI presents, on a first display device of a first device 210 of a first user, a user interface for a user account with an online platform. For example, the online platform may be an online bookkeeping/accounting platform maintaining bookkeeping accounts for a plurality of entities and providing an online bookkeeping service to users.

At 304, the GUI presents, in the user interface, a first display object comprising a payment progress indicator. The payment progress indicator 100A-100E is representative of a payment plan for paying a debt, such as an invoice, bill or loan. The payment plan is a combination payment plan comprising at least two different payment schedules.

In some embodiments, prior or before providing or presenting the first display in the user interface, the GUI is configured to present, in the user interface, a second display object comprising a first user selectable option to select a payment plan type from a set of payment plan types for the debt. At least one of the payment plan types of the set is the combination payment plan comprising at least two different payment schedules. In response to determining, by the GUI, a user selected combination payment plan from the set of payment plan types, the GUI presents, in the user interface, the first display object comprising the payment progress indicator 100A-100E.

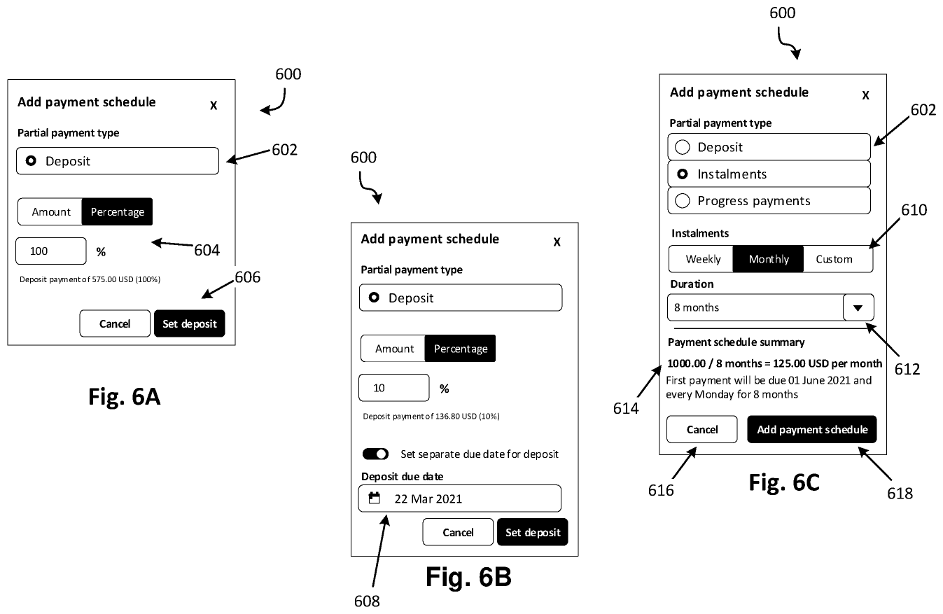

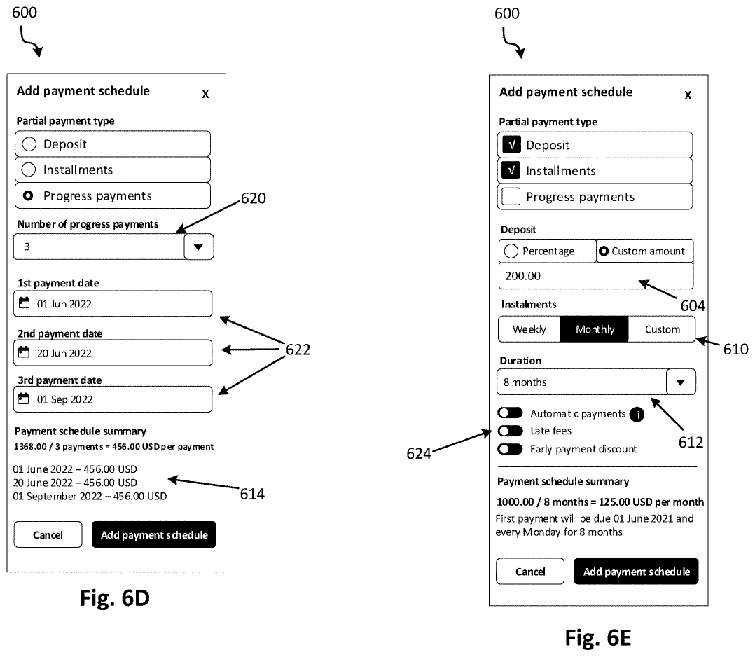

Examples of the second display object comprising the first user selectable option to select a payment plan type are illustrated in FIGS. 6A to 6E, as discussed in more detail below.

In some embodiments, the GUI determines a first due date associated with the first payment schedule of the combination payment plan and a second due date associated with the second payment schedule. The first due date is the date by which a first portion of the debt as represented by the first component is due to be paid and the second due date is the date by which a second portion of the debt as represented by the second component is due to be paid. In some embodiments, the first and/or second due date comprises a plurality of consecutive intermittent due dates, wherein each second intermittent due date is the date by which an instalment or progress payment of the payment schedule is due to be paid. A latest of the intermittent due dates corresponds to the respective due date. In some embodiments, the second display object may provide one or more user selectable options or inputs to allow a user to select or designate the first and/or second due date.

The payment progress indicator 100A-100E comprises a first component 102A-102E representative of a first of the payment schedules of the combination payment plan and a second component 104A-104E representative of a second of the payment schedules of the combination payment plan. The first component 102A-102E is distinct from the second component 104A-104E. For example, the first component 102A-102E is separate from the second component 104A-104E, and in some embodiment, spaced apart from the second component 104A-104E. The second component 104A-104E may be positioned alongside the first component 102A-102E within the progress indicator 100A-100E.

At 306, the GUI determines that a payment has been received. In some embodiments, the GUI may receive payment progress indicator data from the bookkeeping system 260. For example, the GUI may receive payment progress indicator data from a microservice using the backend for the frontend (BFF) pattern. In some embodiments, the GUI may transmit Application Programming Interface (API) calls to an API of the bookkeeping system 260 regularly, irregularly, and/or at scheduled times. For example, the GUI may transmit API calls at times that align with expected payments being made, such as close to or on the due date. In some embodiments, the bookkeeping system 260 may proactively transmit payment progress indicator data to the GUI when a change in status of the account, such as receipt of payment, has occurred.

The payment progress indicator data may comprise a notification of payment or part payment of the debt associated with the payment progress indicator 100A-100E. The notification may comprise one or more of: an amount paid; a date of payment; a due date for the payment; an overall amount of the debt that has been paid to date, and/or an overall amount of the debt that is due. At 308, the GUI determines to which of the first and second payment schedules the payment relates. For example, the GUI may determine to which of the first and second payment schedules the payment relates based on a number and type of previous payments made, the current status or state of the payment progress indicator, an amount of the payment made, the date of payment, the due date for the payment, the due date for the next payment, the overall amount of the debt that has been paid to date, and/or the overall amount of the debt that is due.

At 310, the GUI modifies at least a portion of the respective first or second components 102A-102E, 104A-104E (the one to which it has been determined that the payment relates at 308) to indicate that the payment has been made.

In some embodiments, the first and/or second component 102A-102E, 104A-104E comprises one or more elements 106A-106E. In such embodiments, modifying the at least a portion of the respective first or second components 102A-102E, 104A-104E to indicate that the payment has been made comprises adjusting an appearance of element(s) 106A-106E. For example, adjusting the appearance of element(s) comprises one or more of: (i) increasing or decreasing a size of the at least one element; (ii) changing a shape of the at least one element; (iii) changing a colour of the at least one element; and (iv) shading or hashing the at least one element.

In some embodiments, the appearance of the element(s) 106A-106E is adjusted by an adjustment measure. The adjustment measure may be reflective of or indicative of the received payment relative to an overall amount of the debt, such as the overall amount of an invoice or bill.

In some embodiments, the first component 102A-102E or the second component 104A-104E comprises a progressive bar, an example of which is illustrated in FIGS. 1C to 1E (reference numerals 102C, 104D and 104E, respectively). The GUI may be configured to modify the appearance of the progressive bar by progressing a slider of the progressive bar from a first side of the progressive bar toward a second side of the progressive bar by the adjustment measure. The progressive bar may be representative of a flexible payment arrangement whereby the payer is authorised to make various sized instalments, and in some embodiments, any sized instalment. In some embodiments, the instalments are fixed sized or amount instalments. The progressive bar, by way of the slider, may illustrate the instalments as a continuous flow of payment, as opposed to the instalments represented by non-contiguous elements as with other embodiments.

In some embodiments, at least one element 106A-106E of the first component 102A-102E or the second component 104A-104E comprises a single section indicative of a deposit payment. Examples of these types of combination payment plans are shown in FIGS. 1A, 1B and 1E (reference numerals 102A, 102B and 102E, respectively).

In some embodiments, the first component 102A-102E and/or second component 104A-104E comprises a plurality of elements 106A-106E, and each element 106A-106E is a non-contiguous section. Each non-contiguous section may be indicative of an instalment of the respective payment schedule of the first component 102A-102E and/or second component 104A-104E. The non-contiguous sections may be equally sized representing equally sized instalments. Examples of these types of combination payment plans are shown in FIGS. 1A and 1C (reference numerals 104A and 104C, respectively). In some embodiments, at least some of the non-contiguous sections may be different in size, representing respective differently sized instalments. Examples of these types of components are shown in FIGS. 1B and 1D (reference numerals 104B and 102D, respectively).

An example of the progressive modification of the first and second components, 402, 404 of a payment progress indicator 400 as successive part payments or instalments of a debt (for example, an invoice) are received is shown in FIG. 4. In this embodiments, the first component 402 represents a deposit payment, and the second component 404 comprises a plurality of non continuous equally sized sections 406. The first of the payment progress indicators 400 shows that no payment has yet been made, with none of the elements 406 of the first or second components 402, 404 being modified in that they are all non-shaded; they all assume an initial unmodified state. The second of the payment progress indicators shows that a deposit of USD500 has been paid, with the sole element 406 of the first component 402 being changed to a modified state; in this case, it is shaded. All elements 406 of the second component 404 remain in the initial unmodified state signalling that there are five equal sized instalments of the overall debt yet to be paid, which in this example, totals USD1,480. As with the second payment progress indicator 400, the third payment progress indicator 400 shows that the deposit of USD500 has been paid, with the sole element 406 of the first component 402 being changed to a modified state (i.e. is shaded). The third payment progress indicator 400 also shows that a first instalment of the overall number of instalments to be paid has been paid, with a first element 406 of the second component 404 having been changed to a modified state (i.e. it is shaded). The fourth, fifth and sixth payment progress 400 indicator show progressive payments of further instalments, until all instalment shave been paid, and all elements 406 of the first and second components 402, 404 of the payment progress indicator 400 have been changed to a modified state (i.e. are shaded).

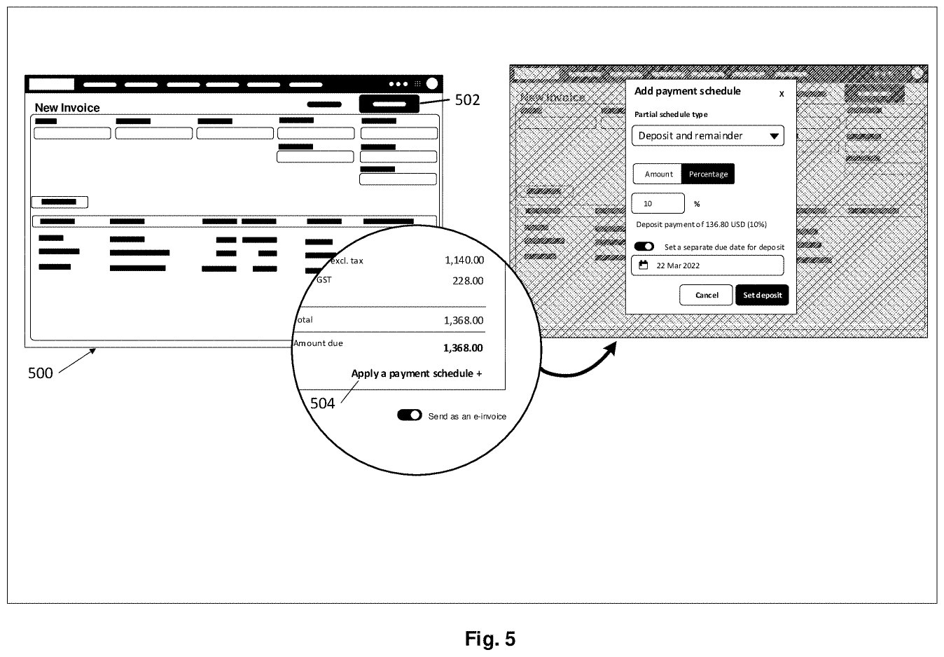

In some embodiments, the GUI is provided to an invoicing party user, such as a merchant or a service provider. As illustrated in FIG. 5, the GUI may present in the user interface 500, a third display object comprising a second user selectable option 502 to create an invoice or a bill or a statement for a second user. On determining that the second user selectable option 502 to create the invoice has been selected, the GUI may be configured to present, in the user interface 500, the second display object 504 to allow the user to select the payment plan type for the invoice.

Examples of the third display object 504 comprising the second user selectable option 502 to select a payment plan type are illustrated in FIGS. 6A to 6E. FIG. 6A illustrates a display object 600 comprising a first user selectable option 602 which allows a user to select a deposit payment plan type. As illustrated, the display object 600 may also provide the user with a user selectable option 604 of setting a deposit amount as a fixed amount or as a percentage of an overall amount or cost. The display object 600 also provides the user with a user selectable option 606 to set or save the settings selected, that is the payment plan type and the deposit as a fixed amount or as a percentage.

The display object 600 of FIG. 6B differs from that of FIG. 6A in that it provides a further user selectable option 608 for the user to select a separate due date for payment of the deposit. In this example, the user selectable option 608 comprises a toggle switch, which when activated provides deposit due date window to allow the user to select an appropriate due date.

The display object 600 of FIG. 6C differs from that of FIGS. 6A and 6B in that the first user selectable option 602 allows a user to select from one of a deposit, instalments or progress payments. The deposit option is represented in an associated payment progress indicator by components 102A, 102B, 102E, for example. The instalment option is represented in an associated payment progress indicator by components 104A, 104B, 104C, for example. The progress payments option is represented in an associated payment progress indicator by components 102C, 106D, 106E, for example. In FIG. 6C, the user has selected the option of “Instalments” and accordingly, options for regularity of payment of instalments (weekly, monthly, custom, for example) 610 and a duration of payments 612 is presented to the user for selection. As shown, the display object 600 may also indicate how much each instalment would be based on a user's selection of the desired regularity and duration in a payment schedule summary 614. User selectable options to cancel 616 or add 618 the selected payment schedule are also provided.

In the display object 600 of FIG. 6D, the payment plan type “Progress payments” is selected. When this option is selected, the user is provided with the opportunity to input a number 620 of progress payments to be made, and respective due dates 622 for each of those progress payments. As shown, the display object 600 may also indicate when and how much each progress payment would be based on the user's selection of the number of progress payments to be made and due dates in a payment schedule summary 614.

The display object 600 of FIG. 6E illustrates a situation where a user has selected a combination payment plan type by selecting both options of deposit and instalments. An example of a payment progress indicator representative of this election may be that of FIG. 1A. As illustrated, in response to selection of these two types of payment plan types, the display object 600 provides the option 604 for the user to set the deposit as a percentage of the overall amount due, or as a custom, fixed amount.

The display object 600 provides an option for the user set the regularity 610 of the instalments and the duration 612. A further option 624 is provided to allow a user to approve or require automatic payments, late fees and/or early payment discounts. In the illustrated example, these options are provided as toggle switches.

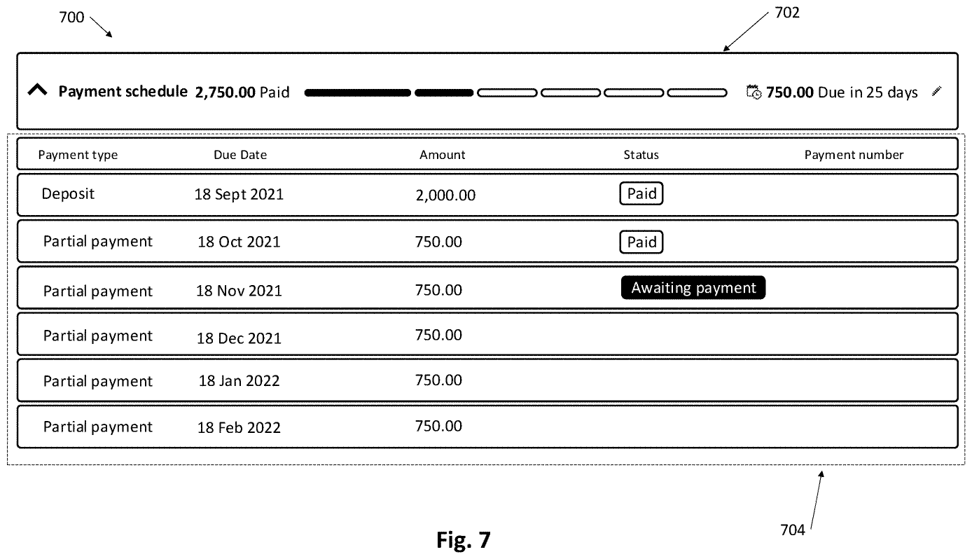

An example image depicting a fourth display object 700 of a GUI for the first display device of the first device 210, as may be provided to an issuing entity, such as a service provider or merchant, is shown in FIG. 7. The fourth display object 700 may comprise a payment progress indicator 702. The fourth display object 700 may comprise a list 704 of payments paid and/or due according to the payment schedules of the combination payment plan being represented by the payment progress indicator 704. For example, the list 704 may include a plurality of rows, each row being associated with a payment or instalment of the combination payment plan. The list 704 may include a plurality of columns. For example, the columns may identify a payment type (e.g., deposit, instalment, partial payment etc.), a due date for the payment, an amount, a status of the payment (e.g., due, overdue, paid etc.) and/or a payment identifier, such as a payment number.

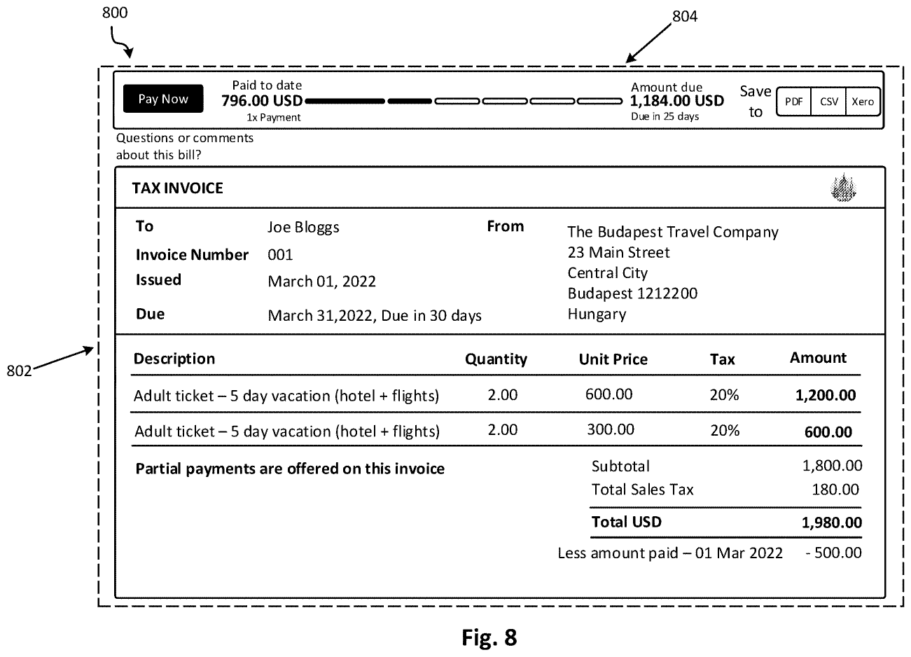

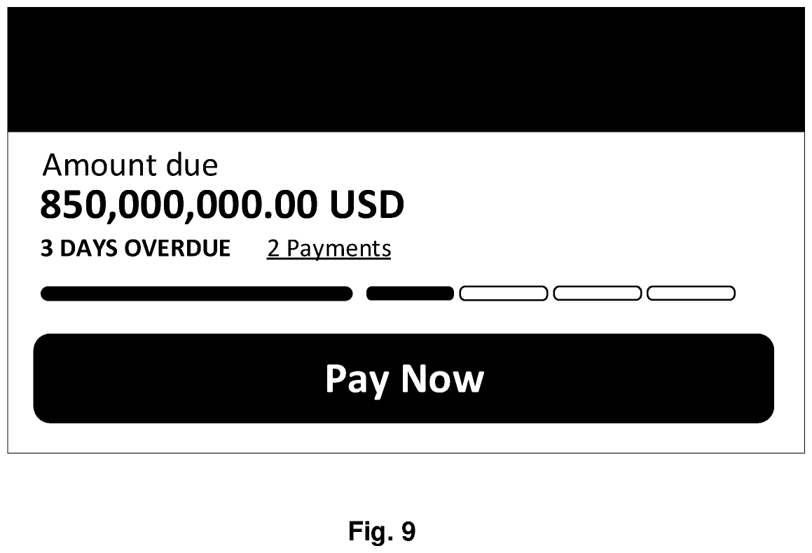

In some embodiments, and as exemplified in FIG. 8, a GUI of a second display device of a second device 210 of the second user (for example, the invoiced entity or payer) may present a fifth display object 800 to the second user, the fifth display object 800 comprising the invoice 802 and the progress payment indicator 804 associated with the invoice; in other words, the progress payment indicator configured to represent the state of payment of the invoice. In some embodiments, and as exemplified in FIG. 9, a GUI of a second display device of a second device 210 of the second user (for example, the invoiced entity or payer) may present a sixth display object 900 to the second user. The sixth display object 900 may comprise the progress payment indicator 904 associated with the invoice and user-selectable option to pay the invoice, or an instalment or part of the invoice.

In some embodiment, the first user may be an invoicing party or entity. In such embodiments, as described above, the invoicing party or entity may be provided with the opportunity to set the combination payment plan for an invoice, for example using the display object 600. As illustrated in FIG. 5, this option may be provided to the invoicing party while creating an invoice or once an invoice has been created.

In some embodiments, the first user may be the invoiced party or entity which may be provided with an opportunity to set the combination payment plan for an invoice, for example using the display object 600, on receipt of notification of a debt (for example, an invoice, bill or statement) from an issuing party. For example, the display object 600 may provide the first user with a user selectable option to request a payment schedule for paying the debt. The merchant or invoicing entity may then decide whether to accept or reject the requested payment schedule.

In some embodiment, the first user may be a purchaser or customer of an e-commerce website, and the first user may be provided with an with an opportunity to set the combination payment plan for an invoice, for example using the display object 600, when making a purchase. The merchant or invoicing entity may then decide whether to accept or reject the requested payment schedule.

A situation whereby an overpayment or an underpayment is made may occur from time to time. As discussed above, when a payment is made, a notification is saved as payment progress indicator data. The notification may comprise one or more of: an amount paid; a date of payment; a due date for the payment; an overall amount of the debt that has been paid to date, and/or an overall amount of the debt that is due. The GUI may be configured to determine whether an overpayment and/or underpayment has been made based on the payment progress indicator data for the debt, and in some embodiments, the combination payment plan type allocated to the debt. For example, an overpayment may be an overpayment of the total amount of the debt, or an overpayment of a deposit, and/or an instalment, according to the payment schedule(s) for the debt.

Responsive to determining that an overpayment/underpayment has been made or occurred, the GUI may be configured to determine a modified first and/or second payment schedule based on the overpayment, and modify at least a portion of the respective first and/or second components to reflect the overpayment.

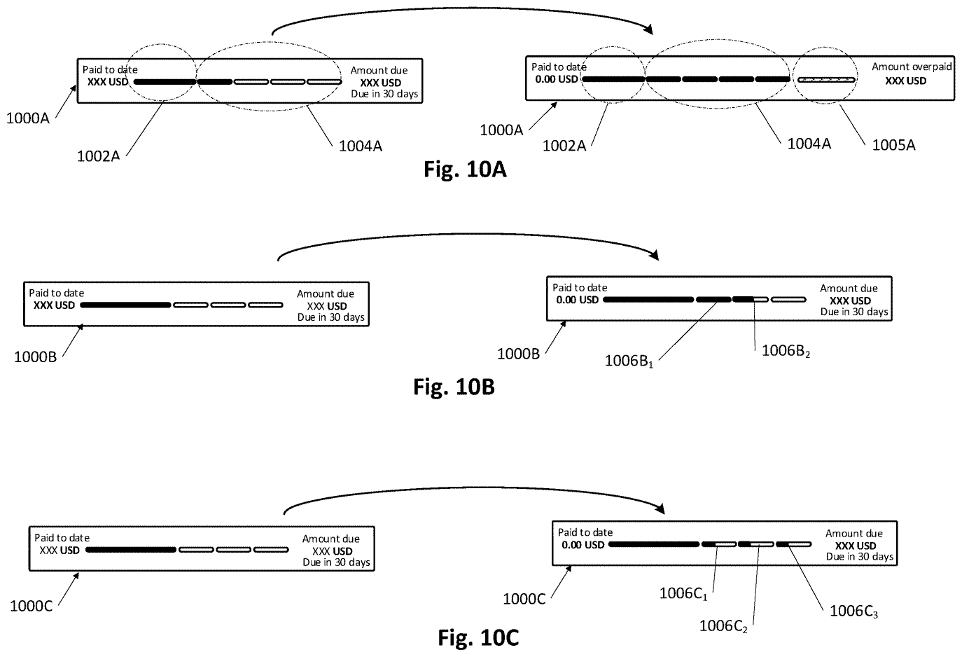

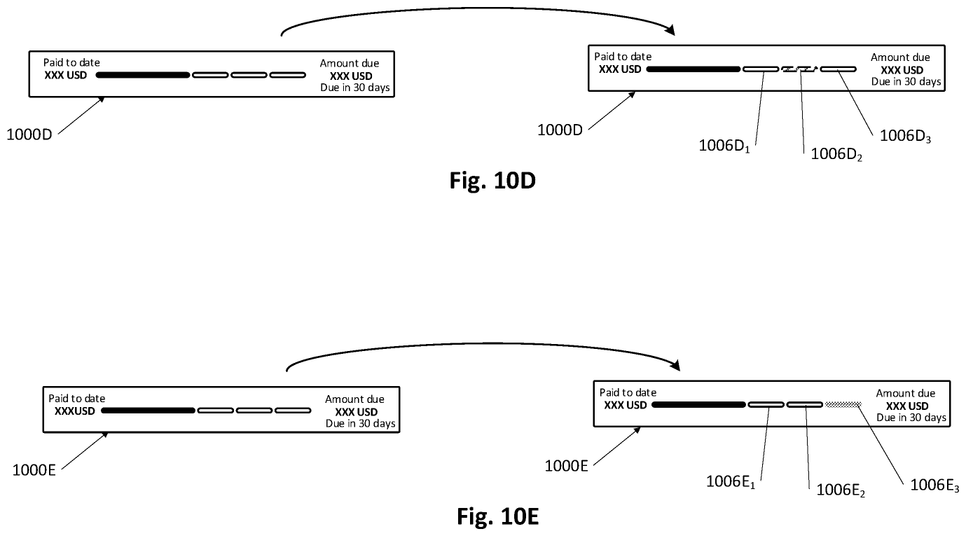

In some embodiments, responsive to an amount paid exceeding the overall amount of the debt due, the GUI may determine that an overpayment has been made. Responsive to determining that an overpayment of the overall amount of the due has occurred, the GUI may be configured to regenerate or update or adjust the appearance of the payment progress indicator 100 to supplement it with an additional or third component 1005A (FIG. 10) indicative of the overpayment. For example, the third component 1005A may be representative of a credit the payer retains with the payee or may be representative of a refund to be repaid, or scheduled for issuance to the payee. The third component 1005A may be shown as a separate, distinct component from the first and/or second components 102, 104, or may be shown as an extension of the first and/or second components 102, 104. An example of a payment progress indicator 1000A comprising the third component 1005A indicative of the overpayment is shown in FIG. 10A.

In embodiments where the amount paid exceeds the deposit and/or an instalment amount, but does not exceed the overall amount of the debt due, the GUI may be configured to modify the payment schedule of one or both of the payment plan types of the payment progress indicator. For example, the GUI may be configured to: (i) reduce an amount of the next instalment due by the amount of the overpayment; (ii) reduce the amount of each remaining instalment; (iii) reduce the frequency of the instalments; and/or (iv) reduce the number of repayments. In other words, the GUI may be configured to take one or more of these approaches in combination.

In some embodiments, responsive to determining that an amount paid exceeds an amount of the payment schedule(s) of the combination payment plan type of the payment progress indicator, the GUI determines a lesser amount to be paid for the next one or more instalments due. The GUI may modify or regenerate the payment progress indicator to reflect the change.

The lesser amount may be the instalment amount less the overpayment. The overpayment may be offset against the upcoming instalments sequentially. For example, where the overpayment is less than an amount of a next instalment due, this may result in the amount of the next occurring instalment due being reduced by the overpayment amount. Where the overpayment is greater than the amount of a next instalment due, this may result in the next instalment being considered paid in full, with a subsequent occurring instalment due being reduced by the excess part of the overpayment. An example of such an embodiment of the payment progress indicator 1000B is depicted in FIG. 10B. As shown in the payment progress indicator, the change in amount due for next instalments may be depicted as the whole or a fraction of the respective elements being modified or highlighted, such as coloured or shaded or dashed, to reflected that a payment or part payment for those instalments has already been made. In this case, the first element 1006B₁ and part of the second element 1006B₂ of the second component 1004B are modified as a result of the overpayment.

In some embodiments, the GUI may split the overpayment across multiple deposits and/or instalments due to thereby reduce the amounts of multiple instalments. For example, in some embodiments, the GUI may recalculate the instalment amounts based on the new outstanding debt amount, determined as a result of the overpayment. An example of such an embodiment of the payment progress indicator 1000C is depicted in FIG. 10C. As shown in the payment progress indicator, the change in amount due for each instalment may be depicted as a fraction or portion of each element 1006C₁, 006C₂, 1006C₃, being altered or highlighted, such as coloured or shaded, to reflected that a part payment for those instalments has already been made.

In some embodiments, responsive to determining that an amount paid exceeds an amount of the payment schedule(s) of the combination payment plan type of the payment progress indicator, the GUI determines a reduced frequency of repayments of the remaining debt. For example, the original payment schedule may have involved instalments being paid on a weekly basis, and in response to the overpayment, the frequency of the repayments has been reduced to a fortnightly basis. An example of such an embodiment of the payment progress indicator 1000D is depicted in FIG. 10D. As shown in the payment progress indicator, the change in frequency of instalments may be depicted by de-emphasising, fading or greying out elements representing instalments that are no longer due for payment.

In some embodiments, responsive to determining that an amount paid exceeds an amount of the payment schedule(s) of the combination payment plan type of the payment progress indicator, the GUI determines a reduced number of repayments of the remaining debt. The GUI may be configured to determine which instalments to eliminate from the payment schedule based on user input, business needs and/or time of year/season. For example, the number of repayments may be reduced by cancelling one or more instalments due at the start of a new financial year. The debt may be paid early by cancelling the last one or more instalments due. An example of such an embodiment of the payment progress indicator 1000E is depicted in FIG. 10E. As shown in the payment progress indicator, the change in number of instalments may be depicted by de-emphasising, fading or greying out element(s) 1006E₃ representing instalments that are no longer due for payment.

Similarly, in embodiments where the amount paid falls short of the deposit and/or an instalment amount, but some payment has been made, the GUI may be configured to modify the payment schedule of one or both of the payment plan types of the payment progress indicator. For example, the GUI may be configured to: (i) increase an amount of the next instalment due by the amount of the underpayment; (ii) increase the amount of each remaining instalment; (iii) increase the frequency of the instalments; and/or (iv) increase the number of repayments. In other words, the GUI may be configured to take one or more of these approaches in combination.

In some embodiments, responsive to determining that an amount paid falls short of an amount of the payment schedule(s) of the combination payment plan type of the payment progress indicator, the GUI determines a greater amount to be paid for the next one or more instalments due. The GUI may modify or regenerate the payment progress indicator to reflect the change.

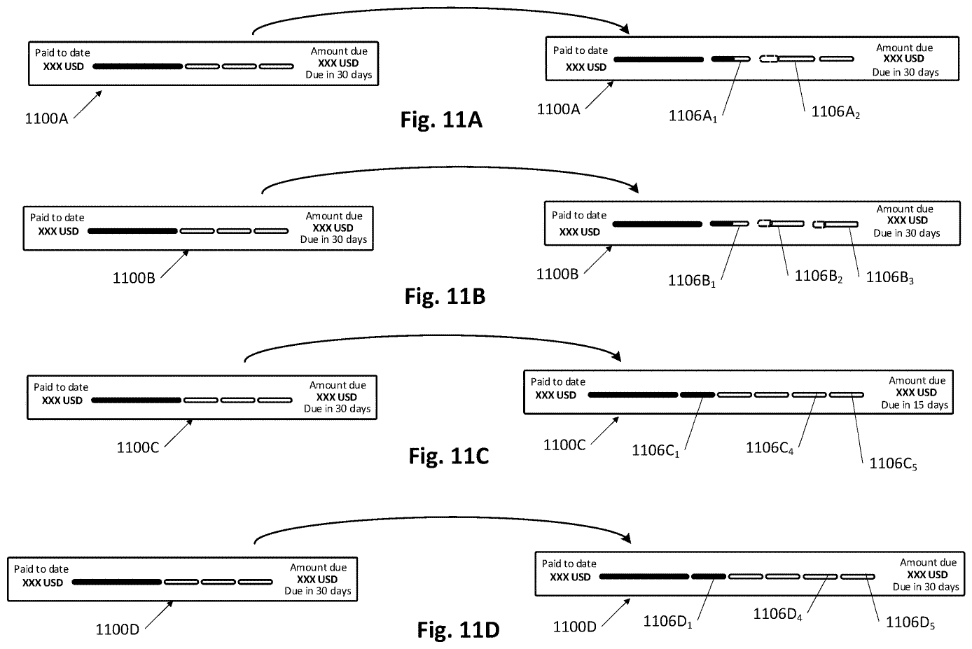

The greater amount may be the instalment amount plus the underpayment. The underpayment may be applied to the upcoming instalments sequentially. An example of the payment progress indicator 1100A of such an embodiment is depicted in FIG. 11A. As shown in the payment progress indicator 1100A, the change in amount due for next instalment may be depicted as an extension to the respective element, which may be highlighted, such as coloured or shaded, to reflect that an additional amount is due as a result of an underpayment of a previous instalment or deposit. In some embodiments, as shown, the element depicting the deposit or instalment that was underpaid may be modified such as part shaded or highlighted to show that the full instalment amount was not paid.

In some embodiments, the GUI may apply the underpayment across multiple deposits and/or instalments due to thereby increase the amounts of multiple instalments. For example, in some embodiments, the GUI may recalculate the instalment amounts based on the new outstanding debt amount, determined as a result of the underpayment. An example of such an embodiment of the payment progress indicator 1100B is depicted in FIG. 11B. As shown in the payment progress indicator, the change in amount due for each instalment may be depicted as an extension to the respective element, which may be highlighted, such as coloured or shaded or dashed, to reflect that an additional amount is due as a result of an underpayment of a previous instalment or deposit.

In some embodiments, responsive to determining that an amount paid falls short of an amount of the payment schedule(s) of the combination payment plan type of the payment progress indicator, the GUI determines an increased frequency of repayments of the remaining debt. For example, the original payment schedule may have involved instalments being paid on a fortnightly basis, and in response to the underpayment, the frequency of the repayments has been increased to a weekly basis. An example of such an embodiment of the payment progress indicator 1100C is depicted in FIG. 11C.

In some embodiments, perhaps only a few additional instalments may be added. As shown in the payment progress indicator, the change in frequency of instalments may be depicted by adding new elements representing additional instalments due, and in some embodiments, highlighting or emphasising the new elements to reflect that they are as a result of an earlier underpayment.

In some embodiments, responsive to determining that an amount paid falls short of an amount of the payment schedule(s) of the combination payment plan type of the payment progress indicator, the GUI determines an increased number of repayments of the remaining debt, which may increase the overall duration of the debt. An example of the payment progress indicator 1100D of such an embodiment is depicted in FIG. 11D. As shown in the payment progress indicator, the change in number of instalments may be depicted by highlighting or emphasising the elements added to represent the additional instalments to be paid.

It will be appreciated that while the examples of FIGS. 11A to 11D depict an indication of the number of days until the payment is due, in an alternative embodiment, the payment progress indicator may instead, or in addition, depict a number of days by which the payment is overdue, for example, “Overdue by 5 days”.

In some embodiments, the GUI may adjust the appearance of the first and/or second components (or element(s) thereof) by an overpayment or underpayment adjustment measure reflective of the overpayment or underpayment relative to the amount represented by the first and/or second components (or element(s) thereof).

In some embodiments, the GUI is configured to update or regenerate the payment progress indicator to reflect the change in the components as a result of the overpayment or underpayments, but without emphasising or highlighting the changes made as a result of the overpayment or underpayment.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. (canceled)

2. (canceled)

3. (canceled)

4. (canceled)

5. A computer-implemented method comprising:
presenting, on a display device of a first device, a user interface for a user account with an online platform, the user interface providing a first display object comprising a first user selectable option displaying an invoice or bill associated with a debt;
presenting, in the user interface, a second display object comprising a first user selectable option to select a payment plan type from a set of payment plan types for the debt, wherein at least one of the payment plan types of the set is a combination payment plan comprising at least two different payment schedules;
determining, by a processor, a user selected combination payment plan from the set of payment plan types; and
presenting, in the user interface, a third display object comprising a payment progress indicator,
wherein the payment progress indicator comprises a first component representative of a first of the at least two different payment schedules of the combination payment plan and a second component representative of a second of the at least two different payment schedules of the combination payment plan, and
wherein the first component is distinct from the second component; and
responsive to determining that a payment has been received, determining to which of a first payment schedule and a second payment schedule it relates; and
modifying at least a portion of a respective first or second component to indicate that the payment has been made.

6. (canceled)

7. The method of claim 5, wherein the first component and the second component comprises one or more elements, and wherein modifying the at least a portion of the respective first or second component representative to indicate that the payment has been made comprises adjusting an appearance of at least one of the one or more elements.

8. The method of claim 7, wherein adjusting the appearance of at least one element comprises one or more of: (i) increasing or decreasing a size of the at least one element;
(ii) changing a shape of the at least one element; (iii) changing a colour of the at least one element; and (iv) shading or hashing the at least one element.

9. The method of claim 7, wherein adjusting the appearance of at least one of the one or more elements comprises adjusting the appearance of the at least one of the one or more elements by an adjustment measure, and wherein the adjustment measure is reflective of a received payment relative to an overall amount of the debt.

10. The method of claim 9, wherein the first component comprises a progressive bar and wherein modifying the appearance of the progressive bar comprises progressing a slider of the progressive bar from a first side of the progressive bar toward a second side of the progressive bar by the adjustment measure.

11. The method of claim 10, wherein at least one of the one or more elements of the second component comprises a single section indicative of a deposit payment.

12. The method of claim 5, wherein at least one element of the first component comprises a single section indicative of a deposit payment.

13. The method of claim 5, wherein the at least one element of the first component comprises a plurality of elements, each element being a non-contiguous section, and each non-contiguous section being indicative of an instalment of a respective payment schedule of the first component.

14. The method of claim 5, wherein the at least one element of the second component comprises a plurality of elements, each element being a non-contiguous section, and each non-contiguous section being indicative of an instalment of a respective payment schedule of the second component.

15. The method of claim 13, wherein the non-contiguous sections are:
(i) equally sized representing equally sized instalments; or,
(ii) different in size, representing respective differently sized instalments.

16. (canceled)

17. The method of claim 5, further comprising:
determining, by the processor, a first due date associated with the first payment schedule of the combination payment plan and a second due date associated with the second payment schedule, wherein the first due date is a date by which a first portion of the debt as represented by the first component is due to be paid and the second due date is a date by which a second portion of the debt as represented by the second component is due to be paid.

18. The method of claim 17, wherein the second due date is later than the first due date.

19. The method of claim 17, further comprising:
determining, by the processor, a plurality of consecutive second intermittent due dates, wherein each second intermittent due date is a date by which an instalment of the second payment schedule is due to be paid, and wherein a latest of the second intermittent due dates corresponds to the second due date.

20. The method of claim 19, wherein the plurality of consecutive second intermittent due dates is determined based on a number of instalments to be made or a regular payment cycle.

21. The method of claim 17, wherein determining, by the processor, the first due date and the second due date comprises receiving as user inputs, the first due date and the second due date.

22. (canceled)

23. (canceled)

24. The method of claim 5, further comprising:
responsive to determining that an overpayment or an underpayment has been made:
determining a modified first and/or second payment schedule based on the overpayment or underpayment; and
modifying at least a portion of the respective first and/or second component to reflect the overpayment or underpayment.

25. The method of claim 24, wherein determining the modified first and/or second payment schedule based on the overpayment or underpayment comprising one or more of:
(i) reducing or increasing an amount of a next instalment due by the amount of the overpayment;
(ii) reducing or increasing an amount of one or more remaining instalment;
(iii) reducing or increasing a frequency of future instalments; and/or
(iv) reducing or increasing a number of future repayments.

26. (canceled)

27. (canceled)

28. A system, comprising:
memory having instructions embodied thereon; and
one or more processors configured by the instructions to perform operations including:
presenting, on a display device of a first device, a user interface for a user account with an online platform, the user interface providing a first display object comprising a first user selectable option displaying an invoice or bill associated with a debt;
presenting, in the user interface, a second display object comprising a first user selectable option to select a payment plan type from a set of payment plan types for the debt, wherein at least one of the payment plan types of the set is a combination payment plan comprising at least two different payment schedules;
determining a user selected combination payment plan from the set of payment plan types;
presenting, in the user interface, a third display object comprising a payment progress indicator,
wherein the payment progress indicator comprises a first component representative of a first of the at least two different payment schedules of the combination payment plan and a second component representative of a second of the at least two different payment schedules of the combination payment plan, and
wherein the first component is distinct from the second component; and
responsive to determining that a payment has been received, determining to which of a first payment schedule and a second payment schedule it relates; and
modifying at least a portion of a respective first or second components to indicate that the payment has been made.

29. (canceled)

30. A non-transitory machine-readable storage medium storing instructions which, when executed by one or more processors, cause the one or more processors to perform operations including:
presenting, on a display device of a first device, a user interface for a user account with an online platform, the user interface providing a first display object comprising a first user selectable option displaying an invoice or bill associated with a debt;
presenting, in the user interface, a second display object comprising a first user selectable option to select a payment plan type from a set of payment plan types for the debt, wherein at least one of the payment plan types of the set is a combination payment plan comprising at least two different payment schedules;
determining a user selected combination payment plan from the set of payment plan types; and
presenting, in the user interface, a third display object comprising a payment progress indicator,
wherein the payment progress indicator comprises a first component representative of a first of the at least two different payment schedules of the combination payment plan and a second component representative of a second of the at least two different payment schedules of the combination payment plan, and
wherein the first component is distinct from the second component; and
responsive to determining that a payment has been received, determining to which of a first payment schedule and a second payment schedule it relates; and
modifying at least a portion of a respective first or second component to indicate that the payment has been made.

31. A graphical user interface (GUI) for display on a display screen of a user device, the GUI comprising:
a first frame occupying a first frame region of a window occupying all or a portion of the display screen;
a payment progress indicator displayed within the first frame, the payment progress indicator being representative of a combination payment plan for payment of invoice debt, the combination payment plan comprising at least two different payment schedules,
wherein the payment progress indicator comprises a first component representative of a first of the at least two different payment schedules of the combination payment plan and a second component representative of a second of the at least two different payment schedules of the combination payment plan,
wherein the first component is distinct from the second component, and
wherein, responsive to determination of payment associated with one of a first payment schedule and a second payment schedule, at least a portion of the respective first or second component representative is modified to indicate that the payment has been made.

32-49. (canceled)
